(19) United States
(12) Patent Application Publication
(10) Pub. No.: US 2015/0275629 A1
(43) Pub. Date: Oct. 1, 2015

(54) CONNECTION APPARATUS

(71) Applicant: MAGMA GLOBAL LIMITED, Portsmouth (GB)

(72) Inventor: Stephen Hatton, Surrey (GB)

(73) Assignee: Magma Global Limited, Hampshire (GB)

(21) Appl. No.: 14/426,503

(22) PCT Filed: Sep. 13, 2013
(86) PCT No.: PCT/GB2013/052395

§ 371 Date: Mar. 6, 2015

(30) Foreign Application Priority Data
Sep. 13, 2012 (GB) 1216344.0

(51) Int. Cl. E21B 43/013; F16L 27/12; F16L 43/02

(52) U.S. Cl. CPC E21B 43/013; F16L 43/02; F16L 27/12

(57) ABSTRACT

An apparatus (10) for providing fluid communication between first and second connection points (34,38) comprises a deformable pipe assembly (12) including a composite material. A first connector (34) is mounted at one end of the deformable pipe assembly and is configured for connection with a first connection point and a second connector (38) is mounted at an opposite end of the deformable pipe assembly and is configured for connection with a second connection point. An adjusting assembly (44) is configured to apply a force between separated regions of the deformable pipe assembly, such that deformation of the deformable pipeline assembly is responsive to the adjusting assembly to permit a relative separation of the first and second connectors to be adjusted.

### FIELD OF THE INVENTION

The present invention relates to an apparatus for use in providing fluid communication between first and second connection points, such as those provided in two piping systems.

### BACKGROUND OF THE INVENTION

The subsea oil and gas industry uses subsea Xmas trees, manifolds, flowlines and pipelines to produce and export hydrocarbons. These subsystems are connected by piping spools that provide pressure tight communication from one package to another.

Typically, pipe spools are pre-designed with a specified geometry and length, which may be typically in the range 1 to 100 m. Each opposing end of a pipe spool is connected to a corresponding subsea equipment package using an interface hub or flange.

Pipe spools require exacting specifications in order to allow installation and perform correctly during their service life. The piping spool typically consists of a length of pipe, incorporating a number of 90 degree bends with a flange or other mechanical connector at each end. The connection system allows the spool to be connected at each end to a subsea package, thereby allowing the two packages to be sealingly connected.

Therefore, for reliable operation, the positional tolerance of the mechanical connector and their mating hubs is critical. Further, the pipe spool should be able to accommodate movement of the hubs mounted on the subsea packages. During installation and while in use, the pipe spool may be subjected to external occurrences, for example, thermal distortion, environmental loading or pressure loading.

Pipe spools therefore require significant preparation before installation and are expensive to design, fabricate, install and operate due to the associated weight and proportions. Further, pipe spools must be sufficiently strong to accommodate external and internal pressure loadings and other operational loads.

For example, since the separation of the mechanical connectors of the pipe spool must match the separation of the corresponding mating hubs on sub sea packages, it is often necessary to wait until the sub-sea packages are installed before producing the pipe spool, to ensure the connectors of the pipe spool have the correct separation. It will be appreciated that this may result in delays in the installation of subsea systems and results in very strict manufacturing tolerances.

Typically, pipe spools may be constructed using metals such as steel, which provides high strength and a relatively high stiffness. Therefore, multiple bends or elbow pipes may be required in the pipe spool to provide the necessary flexibility to aid installation and allow movement in service. Pipe spools may also be manufactured using non bonded flexible pipe, but this is expensive and difficult to install without damage. These uncertainties associated with the design, fabrication, preparation, installation and operation of pipe spools prevents easy, reliable, low maintenance and low-cost implementation of the pipe spool and subsea architecture in general. The failure rate associated with this kind of pipe spool represents a risk to ongoing production. As such, stopping the efficient extraction and production of oil is an identifiable problem with existing types of pipe spools.

Therefore, there is a need to provide a pipe spool which can accommodate all of the occurrences associated with oil and gas extraction and production.

### SUMMARY OF THE INVENTION

The present applicant has invented an apparatus which deals with issues relating to existing pipe spools known in the art. Accordingly, the present applicant has invented a deformable pipe assembly that can be adjusted in situ to provide a connection between connecting terminals that is easier to design, easier to install and should offer lower fail rates than at least some prior art apparatus.

According to a first aspect of the present invention there is provided an apparatus for providing fluid communication between first and second connection points, the apparatus comprising:

a deformable pipe assembly comprising a composite material formed of at least a matrix and a plurality of reinforcing elements embedded within the matrix;

a first connector mounted at one end of the deformable pipe assembly and configured for connection with a first connection point;

a second connector mounted at an opposite end of the deformable pipe assembly and configured for connection with a second connection point; and

an adjusting assembly configured to apply a force between separated regions of the deformable pipe assembly, such that deformation of the deformable pipeline assembly is responsive to the adjusting assembly to permit a relative separation of the first and second connectors to be adjusted.

Since the relative separation of the first and second connectors may be selected or varied by using the adjusting assembly to produce a required deformation of the deformable pipe assembly, the manufacturing tolerances in the separation of the first and second connectors may not be as strict. Furthermore, the ability to vary or select the separation of the first and second connectors may allow pre-produced apparatus to be used, which may significantly reduce the installation time of subsea systems that utilise pipe spools.

In use, the apparatus may permit a connection to be made between first and second connection points to, for example, provide a communication path between said connection points. The apparatus may be, comprise or be comprised in a pipe spool. Fluids, solids, particles, equipment and/or other media may be transported between said connection points via the apparatus.

Although apparatus for providing fluid communication that comprises first and second connection points (such as terminals), it will be appreciated that the invention is equally applicable to three or more way connectors having a plurality of connectors, wherein the relative separations of two or more of the connectors may be adjusted by one or more adjusting assemblies.

The separated regions of the deformable pipe may be axially separated, e.g. separated along the length of the deformable pipe.

Each of the separated regions may be axially located equidistantly from the centre of the deformable pipe assembly.

The adjusting assembly may provide a tension between the separated regions.

The apparatus may be configured such that the adjusting assembly is operable to move the first and second connectors together and/or apart. The adjusting assembly may be configured to increase the deformation of the deformable pipe assembly and/or relax an existing deformation of the deformable pipe assembly. The adjusting assembly may be configured to provide an expansive and/or contractive force between the separated regions. At least part of the adjusting assembly may be extendable and/or contractible in at least one direction, for example, along the axis through the separated regions.

The apparatus may be configured such that the relative orientations of the first and second connectors are unchanged by changes in deformation of the deformable pipe by the adjusting assembly. The adjusting assembly may be arranged such that an axis through the separated regions is parallel to an axis defining a separation of the first and second connectors.

During installation, the apparatus may be configured in situ according to the distance of separation between first and second connection points. The ability to configure the apparatus in situ may represent an advantage over the prior art in terms of ease of installation and ability to reconfigure the apparatus for use in providing a communication path between different first and second connection points having different relative separations.

The deformable pipe assembly may comprise at least one flexible portion, such as a flexible pipe portion. The flexible portion(s) may comprise and/or be formed of the composite material. The flexible portion(s) of the pipe assembly may be configured to accommodate deformation within the pipe assembly upon application of physical stimulus, such as the force applied by the adjusting assembly. The flexible portion(s) may be configured to deform in a required manner, for example, to bend, coil, stretch, expand, contract, twist or the like. In particular, the deformable portion(s) may be configured to permit bending according to an applied physical stimulus.

The apparatus may comprise one or more sensors, such as strain sensors. The sensors may be configured to determine at least one property of the flexible portion, such as strain or degree of bending, or a parameter indicative thereof. Such sensors may be usable to determine operational conditions such as a degree of bending of the flexible portion, to warn if the property of the flexible portion such as strain or degree of bending is approaching or beyond operational limits, or to detect operational events such as slugging.

The deformable pipe assembly may be configured to deform in any direction. The deformable pipe assembly may be configured to deform within a plane, as required. Principally, the deformable pipe assembly may be configured to deform within a deforming plane.

The adjusting assembly may be configured such that the axis through the separated regions also lies in the deformable plane.

The flexible portion(s) may be resiliently bendable or flexible,

The matrix may comprise a polymeric material, which may comprise, for example, a thermoplastic such as PEEK. The reinforcing elements may comprise fibres such as carbon fibres, glass fibres, Kevlar fibres, fibres and the like.

The deformable pipe assembly may comprise constructional variations which may provide a varying stiffness along the length of the pipe assembly. The flexible portion may comprise constructional variations which may provide a sufficiently low stiffness to permit deformation, where required.

The apparatus for providing fluid communication may comprise one or more rigid portions, such as rigid pipe portions. The rigid portion(s) may have a stiffness greater than the stiffness of at least part of the flexible portion of the deformable pipe assembly. The rigid portion(s) may be provided between the deformable pipe assembly and/or the flexible portion thereof and the first and second connectors. The rigid portion(s) may be comprised in, integral with or connected/connectable or bonded to the deformable pipe assembly. The rigid portion(s) may be comprised in, integral with or connected/connectable to the first and/or second connector.

The rigid portion(s) may comprise or be formed from metal, such as steel. The rigid portion(s) may comprise or be formed from a composite or polymeric material.

In cases where the one or more rigid portions are comprised in and/or integral with the deformable pipe assembly, the deformable pipe assembly may comprise constructional variations which may provide a sufficiently high stiffness to provide the rigid portion(s), where required.

The rigid portion(s) may be connected to any flexible portion. The rigid portion(s) may comprise the same composite material to that comprised in the flexible portion. The rigid portion may comprise a different material to that comprised in the flexible portion.

The rigid portion(s) may be integrally formed into a unitary body with any flexible portion.

The deformable pipe assembly may comprise a rigid portion situated at one end of the flexible portion of the pipe assembly. The deformable pipe assembly may comprise a different rigid portion situated at the opposite end of the deformable pipe assembly.

One or more of the rigid portions may comprise a bend. The bend may permit the first and second connectors to be directed in a different direction to the direction defined by a longitudinal axis of said deformable pipe assembly. The bend may correspond to any angle between 0 and 180 degrees from the longitudinal axis. The bend may correspond to an angle that is between 75 and 105 degrees, such as substantially at 90 degrees from the longitudinal axis of the deformable pipe assembly.

The composite material may comprise constructional characteristics which may assist in permitting effective storage, operation, installation or the like of the deformable pipe assembly.

The composite material may provide specific constructional characteristics which may complement the deforming capabilities of the deformable pipe assembly. The composite material may provide the deformable pipe assembly with defined constructional properties, for example, durability, strength, rigidity, stiffness, elasticity, flexibility, conductivity, thermal loading, evenly distributed stress/strain loading, unevenly distributed stress/strain loading or the like. The constructional properties of the deformable pipe assembly may define a physical response of the deformable pipe assembly upon being subjected to a physical stimulus, for example, applied force, pressure, temperature, electrical current or the like. The constructional properties of the deformable pipe assembly may define a chemical response of the deformable pipe assembly in the presence of chemicals, for example, water, salt, metal, oil, gas or the like.

The deformable pipe assembly may comprise a constructional variation which may provide, for example, defined physical characteristics in the deformable pipe assembly. The constructional characteristics may be provided by the constructional variations.

The constructional variations in the deformable pipe assembly may comprise a circumferential constructional variation. The pipe assembly may comprise a plurality of circumferential constructional variations. The circumferential variations may comprise diametrically opposed variations in construction.

The constructional variations may comprise variations in thickness, stiffness, strength or the like. For example, the constructional variations may comprise variations in thickness of a pipe wall of the pipe of the deformable pipe assembly, such as thicker and/or thinner portions of the pipe wall.

The constructional variations may comprise provision of a different material to provide different physical characteristics, for example, strength, rigidity, stiffness or the like. The different material may be comprised of, for example, metal, plastic or the like.

The constructional variations may comprise variations in the composite material, for example, variations in type, length, material, layup and/or orientations of the reinforcing members, variations in the relative amounts of reinforcing member and matrix, variations in the material used for the matrix, variations resulting from manufacturing parameters such as processing temperatures, processing pressures, stretching, tensing, humidity, environment, durations of process steps and the like.

The deformable pipe assembly may comprise longitudinal constructional variations which may provide, for example, defined physical characteristics in the deformable pipe assembly. The constructional variations in the deformable pipe assembly may comprise a longitudinal constructional variation. The deformable pipe assembly may comprise a plurality of longitudinal constructional variations.

The deformable pipe assembly may comprise any combination of circumferential and/or longitudinal constructional variations.

The adjusting assembly may be configured to define the deformation of the deformable pipe assembly. The adjusting assembly may be configured to bend the deformable pipe assembly to permit relative movement of the connectors. The relative movement of the connectors may be confined within a connecting plane. The adjusting assembly may permit adjustment of the relative separation of the opposing ends of the deformable pipe assembly.

The adjusting assembly may be configured to define and/or adjust a relative separation between the connectors.

The adjusting assembly may be configured to maintain the defined relative separation between the connectors.

The defined relative separation may be varied by selectively applying, releasing or varying the force between axially separated regions of the deformable pipe assembly. The deformable pipe assembly may be pre-configured by applying a force to obtain a particular relative separation between the connectors ex situ. The action of applying a force to the deformable pipe assembly may deform the deformable pipe assembly from an initially relaxed or less deformed state of the pipe assembly. The adjusting assembly may be configured to restrain the deformable pipe assembly in a deformed state to maintain the deformation in order to prevent the deformable pipe assembly from self-reconfiguring from the deformed state into the relaxed state of said deformable pipe assembly.

The deformable pipe assembly may be configured in situ by adjusting the deformable pipe assembly from any deformed state to any less deformed state, as required.

The pipe assembly may be configured in situ by actively applying a force to change said pipe assembly from an initially relaxed state to any deformed state, as required. The adjusting assembly may subsequently be adjusted to restrain the pipe assembly in the required deformed state.

For example, the adjusting assembly may be configured to apply and/or vary the force between the separated regions to vary the relative separation of the first and second connectors, e.g. to match the relative separation of the corresponding connection points. The adjusting assembly may be configured to release or reduce the force between the separated regions of the deformable pipe assembly, for example, to allow the force applied by the adjusting assembly to be released or reduced after the first and second connectors are connected to the corresponding first and second connection points. In this way, impairment of the natural flexibility of the deformable pipe assembly by forces applied by the adjusting assembly may be reduced or prevented, thereby permitting natural variations in the separation of the connection points to be better accommodated by the flexibility of the deformable pipe assembly.

The adjusting assembly may comprise an adjusting member to define and/or permit adjustment of the relative separation between the connectors. The adjusting member may comprise, for example, a piston, rod, bolt, threaded rod, cable, belt, wire, rope, chain or the like.

The adjusting assembly may comprise at least one coupling, wherein each coupling may attach an end of the adjusting assembly to any axial region of the deformable pipe assembly, such as one of the separated regions. The adjusting assembly may comprise a plurality of couplings. A single adjusting assembly may comprise one adjusting assembly with a coupling attached to each end of the one adjusting assembly.

The adjusting assembly may comprise a coupling situated at each opposing end of said adjusting assembly, such that the adjusting assembly is coupled between the separated regions of the pipe assembly.

The adjusting assembly may be coupled to, and/or configured to apply the force to, a part of the pipe assembly that is separated from a longitudinal axis of the pipe assembly. By applying the force to a point that is radially spaced apart from the longitudinal axis of the pipe assembly, application of a force between the separated regions of the pipe assembly when the pipe assembly is in a straight/unbent configuration may act to bend the flexible pipe assembly rather than to crush it.

The apparatus may comprise a plurality of adjusting assemblies to provide different configurations for adjusting the deformable pipe assembly, for example, two or more adjusting assemblies could be separably attached to the same or different separated regions of the deformable pipe assembly.

The coupling may comprise a coupling component. The couple component may articulate according to the degree of deformation which may occur when a force is applied using the adjustment assembly, such that undesired stress/strain on the adjusting assembly may be minimised. The coupling component may comprise a joint to permit articulation relative to the coupling module, for example, the joint may comprise a knuckle joint, cylindrical joint, turnbuckle joint, ball joint or the like.

The coupling may comprise a rotatable collar, bracket, eyelet or the like. The adjusting assembly may comprise a coupling module which may be integrated within the construction of the deformable pipe assembly.

The coupling component may comprise a fixed or fixable joint to prevent articulation from occurring, for example, the fixed or fixable joint may comprise a welded joint or bolted joint.

The adjusting assembly may comprise a locking module to confine the adjusting member in an adjusted configuration, as required. The locking module may comprise, for example, a buckle, clamp, lever, pin, hook, clip or the like.

The adjusting assembly may comprise one or a plurality of force applicators to apply force upon the deformable pipe assembly via the adjusting member in order to adjust the relative separation between the connectors. The force applicator(s) may comprise, for example, an electric motor, hydraulic actuator, pneumatic actuator, magnetic actuator, a mechanical actuator or the like. It will be appreciated that the actuator may comprise a directly acting mechanism, such as a hydraulic piston, or indirectly acting mechanism, such as a winding mechanism, a concertina mechanism, a threaded drive mechanism or worm drive, or the like. Examples of preferred force applicator(s) include but are not limited to ratchet mechanisms or hydraulic actuators.

In use, the adjusting assembly may permit an external operator to manually adjust and/or restrain the deformable pipe assembly, for example, using a person and/or remotely operated vehicle or the like.

The external operator may adjust the force applicator so that the deformable pipe assembly may be deformed. Once adjusted, the deformable pipe assembly may be configured to maintain the required deformation.

The first connector may be attached to one end of the deformable pipe assembly. The second connector may be attached to an opposing end of the deformable pipe assembly. The first and second connectors may comprise hydraulic connectors, such as those known in the art, and/or a flange based connector.

The first and/or second connector(s) may comprise a swivel or other device for allowing reorientation of the first and/or second connectors, for example, to allow the first and/or second connectors to be rotated. This feature may be particularly suitable for connectors such as flange connectors that need to align with the connectors, e.g. so that the connector can be rotated to allow bolt holes or other fixing means in the flange and connector to be aligned.

The first and second connectors may be directed to face any direction within a connecting plane. The deforming plane may be substantially perpendicular to the connecting plane defined by the first and second connectors.

The first connector may be aligned to permit connection with the first connection point. The second connector may be aligned or alignable to permit connection with the second connection point. The first and second connection points may be directed or directable to face in any direction within the connecting plane. The first and second connectors may connect to the first and second connection points in the connecting plane. Accordingly, the facing direction of the first and second connectors may substantially coincide with the facing direction of the first and second connection points, respectively.

The flexible portion of deformable pipe assembly may be configured to deform in a deforming plane while the first and second connectors may be aligned within the connecting plane to face and connect with the respective first and second connection points.

The connecting plane may be directed vertically from a horizontal plane defined by the situation of the connection points. The horizontal plane could be at any angle relative to a local geographical feature, for example, a seabed, platform or the like. The deforming plane may be parallel to the horizontal plane.

The ability to adjust the relative separation of the connectors of the deformable pipe assembly independently of any deformation in the flexible portion of the deformable pipe assembly may assist in providing an easy and/or simple installation of the apparatus in situ. Accordingly, the apparatus may be installed without adjusting the facing direction of the connectors while simultaneously deforming the deformable pipe assembly.

The pipe may comprise a linking module or a plurality of linking modules to permit connection with an installation apparatus, for example, a lifting device or the like.

The installation apparatus may install and/or maintain the apparatus in situ.

The linking modules may provide a lifting connection between the deformable pipe assembly and the lifting device.

The linking modules may be indirectly connected to the pipe assembly.

The linking modules may comprise, for example, a collar, jacket, eyelet or the like, to provide the lifting connection. The linking modules may be positioned at any axial position within the full length of the deformable pipe assembly. Two linking modules may be positioned at equidistant separations within the deformable pipe assembly to permit stable installation of the apparatus. Additional linking modules may provide additional stability with which to install the apparatus.

According to a second aspect of the present invention there is provided a method for installing an apparatus for providing fluid communication between first and second connection points, the apparatus comprising:

a first connector mounted on the deformable pipe assembly and configured for connection with a first connection point;

a second connector mounted on the deformable pipe assembly and configured for connection with a second connection point; and

a deformable pipe assembly, the deformable pipe assembly comprising at least one flexible portion and at least one rigid portion; wherein

the method comprises:

utilising an adjusting assembly to apply a force between separated regions of the deformable pipe assembly, such that deformation of the deformable pipeline assembly is responsive to the force applied by the adjusting assembly; and

using the adjusting assembly to define a relative separation between the first and second connectors by varying the deformation of the deformable pipeline.

In use, the adjusting assembly may permit adjustment of the relative separation between the connectors to permit in situ installation of the apparatus according to the relative separation between the respective first and second connection points.

Further, during installation, the connectors of the deformable pipe assembly may be configured to remain within the connecting plane while adjusting the deformation of the deformable pipe assembly within a deforming plane to permit a suitably aligned connection with the respective first and second connection points.

The deforming plane may be perpendicular to the connection plane. An axis passing through the separated regions of the pipeline may be parallel to an axis defining a separation between the first and second connectors.

The method may comprise relaxing, loosening or extending the adjusting assembly after the connection apparatus is connected and/or locked to the connection points. In this way, the flexible portion may no longer be placed under tension.

The apparatus may comprise an apparatus described above in relation to the first aspect.

It should be understood that any feature defined in relation to one aspect may be provided in combination with any other aspect.

### BRIEF DESCRIPTION OF THE DRAWINGS

These and other aspects of the present invention will now be described, by way of example only, with reference to the accompanying drawings, in which:

FIG. 1 is an overall perspective view of the apparatus in a deformed configuration.

FIG. 2 is a cross-sectional aspect of a portion of the deformable pipe assembly comprising circumferential constructional variations.

FIG. 3a is a view of the apparatus from above with the relative separation between the connectors being different to the separation between the connection points.

FIG. 3b is a view of the apparatus from above with the relative separation between the connectors being identical to the separation between the connection points.

FIG. 4a is a side-ways view of the apparatus with the relative separation between the connectors being different to the separation between the connection points.

FIG. 4b is a side-ways view of the apparatus with the relative separation between the connectors being identical to the separation between the connection points.

### DETAILED DESCRIPTION OF THE DRAWINGS

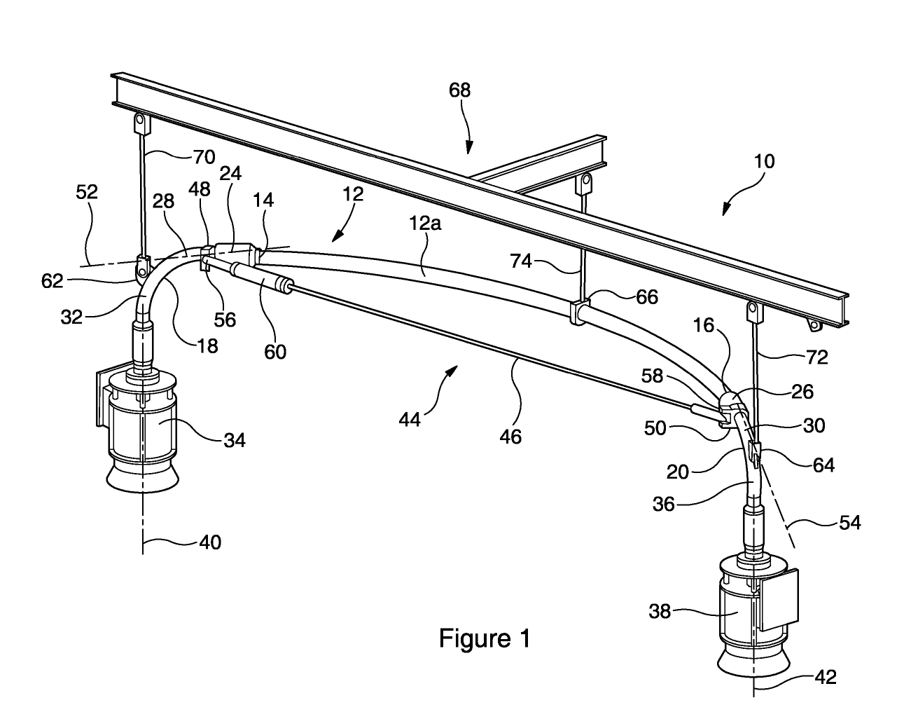

A connection apparatus 10 is shown in FIG. 1. The connection apparatus comprises a deformable pipe assembly 12 that comprises a flexible portion 12a. Opposing ends 14, 16 of the flexible portion 12a are provided with first and second rigid portions 18, 20. The rigid portions 18 and 20 each comprise a bend wherein, in this embodiment, each of the bends are substantially at 90 degrees. However, it will be appreciated that the rigid portions 18 and 20 may comprise a bend at any angle, as required. First and second connectors 34, 38 are provided on the distil ends of the first and second rigid portions 18, 20 respectively. In this way, the deformable pipe assembly 12 defines a communication path from the first and second connectors 34, 38.

The connection apparatus further comprises an adjusting assembly 60 for applying a force on the flexible portion 12a. The adjusting assembly 60 is coupled between the first and second rigid portions at an interface between the respective rigid portions 12, 16, and the ends 14, 16 of the flexible portion 12a.

The flexible portion 12a is adapted to be bendable responsive to the force applied by the adjusting assembly 60. The adjusting assembly 60 is adapted to be extendable and retractable so as to vary the degree of bending of the flexible portion 12a. By varying the degree of bending of the flexible portion 12a, the degree of separation of the first and second connectors 34, 38 can also be varied.

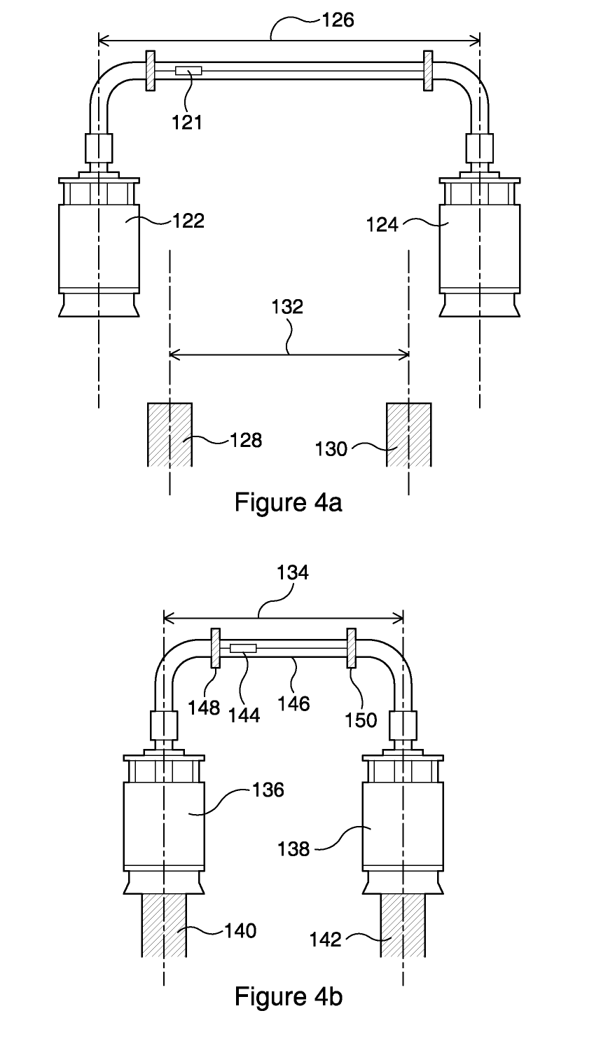

The first and second connectors 34, 38 are configured to connect to respective first and second connection points, for example, terminals 94, 96 (see FIGS. 3a, 3b, 4a and 4b). The first and second connectors 34, 38 extend and couple to the terminals 94, 96 in a connection plane. The deformable pipe assembly and the adjustment apparatus are configured such that the flexible portion 12a bends in a deforming plane that is perpendicular to the connection plane. Furthermore, the adjusting assembly is provided in the deforming plane and is extendable and contractable in a direction that is parallel to a direction defined by the closest separation of the first and second connectors 34, 38.

It will be appreciated that the connection apparatus 10 is configured such that the relative orientations of the first and second connectors 34, 38 are unchanged when they are moved together or apart by bending of the flexible portion 12a. In particular, if the first and second connectors 34, 38 are provided vertically, then the flexible portion may be bent in a horizontal plane to vary the relative separation of the connectors 34, 38 without affecting the verticality of the connectors 34, 38. However, it will be appreciated that the connectors 34, 38 and/or terminals 94, 96 need not be vertical and that other orientations are possible, particularly if the connectors 34, 38 comprise hydraulic connectors.

The connection apparatus 10 can also optionally comprise one or more swivels or other means for reorienting the connectors 34, 38. The ability to reorient (e.g. rotate) the connectors 34, 38 is particularly useful for flanges or other types of connectors in order to allow bolt holes or other fixing means to be aligned.

In this way, varying the deformation of the flexible member 12a can allow the connection apparatus 10 to be configured to provide a communication path between first and second terminals 94, 96 regardless of separation. For example, the separation between terminals could be anywhere between 10 and 50 metres. However, this is not a limiting separation, and as such, the connection apparatus 10 may be deployed to provide a communication path between terminal separations greater or less than the aforementioned separation. The connection apparatus may provide, for example, a communication path for use in transporting fluids, solids, particles, equipment and/or other media between the first and second terminals. The key advantage of the present invention is that the connection apparatus 10 may be adjusted in situ to provide a communication path between different terminals which have a different separation, and also maintaining a substantially precise alignment between the connection apparatus and the terminals (not shown). The connection apparatus 10 may therefore be configured for use in a number of situations without having to be adjusted ex situ beforehand. Therefore, the connection apparatus does not require precise ex situ configuring in order to provide a communication path between any terminals.

In some of the envisaged embodiments, the connection apparatus 10 may be used for transporting fluids associated with subsea hydrocarbon extraction between first and second terminals which may be situated within a subsea environment. However, these are not limiting embodiments. It may be foreseen that the connection apparatus 10 may be configured and deployed between other terminal architecture situated above sea level or on land, wherein a communication path between said terminal architecture is required for the transport of any media.

The flexible portion 12a of the deformable pipe assembly 12 comprises a composite material formed of at least a matrix and a plurality of reinforcing elements embedded within the matrix. For example, the matrix may comprise PEEK and the reinforcing elements may comprise carbon fibres.

The first rigid portion 18 is axially connected to an end 14 of the flexible portion 12a via a first adapting connector 24. The second rigid portion 20 is axially connected to the flexible portion at an opposing end 16 of the flexible portion 12a via a second adapting connector 26. In some embodiments the adapting connectors 24 and 26 may be formed into a unitary body comprising the rigid portions 18 and 20 along with the flexible portion 12a defined by 14 to 16.

The first rigid portion 18 comprises an upper region 28 which may be axially adjacent to the first adapting connector 24. The second rigid portion 20 comprises an upper region 30 which may be substantially axially adjacent to the second adapting connector 26. The first rigid portion 18 comprises a lower region 32 which may be substantially axially adjacent to a first connector 34. The second rigid portion 20 comprises a lower region 36 which may be substantially axially adjacent to a second connector 38. The upper 28, 30 regions are separated from the respective lower regions 32, 36 by the respective bends in the respective rigid portions 18, 20.

The connectors 34 and 38 may each be defined by a connecting axial direction. A first connecting axial direction depicted by 40 shows the connecting axial direction required for permitting connection between the connector 34 and the first terminal 94 (see FIGS. 3a, 3b, 4a and 4b), wherein said first terminal 94 corresponds with the axial direction 40, such that connector 34 is alignable with, and connected to the first terminal 94. A second connecting axial direction depicted by 42 shows the connecting axial direction required for permitting connection between the connector 38 and the second terminal 96 (see FIGS. 3a, 3b, 4a and 4b), wherein said second terminal 96 corresponds with the connecting axial direction 42, such that connector 38 may be aligned with, and connected to the second terminal 96.

Importantly, axial directions 40 and 42 lie within a two-dimensional connecting plane, as defined by said axial directions. However, axial directions 40 and 42 may be directed in any direction within the connecting plane.

The adjusting assembly 44 may be used to define and/or adjust the deformation of the deformable pipe assembly 12. The adjusting assembly 44 comprises an adjusting member 46 comprising a first coupling module 48 positioned at one end of the adjusting member 46 and a second coupling module 50 positioned at an opposite end of the adjusting member 46. The coupling modules 48 and 50 may be used to attach the adjusting member 46 to deformable pipe assembly 12 between axially separated regions along the deformable pipe assembly 12 relating to coupling modules 48 and 50. In the present embodiment, the adjusting assembly 44 is connected at positions that are axially adjacent to adapting connectors 24 and 26. In some embodiments of the present invention, the adjusting assembly is connected to different axial locations relative to adapting connectors 24 and 26.

The adjusting assembly 44 is adjusted to define the deformation of the deformable pipe assembly 12. In the present embodiment, the deformation takes the form of a bending along the flexible portion 14 to 16. The bending of the flexible portion of the pipe assembly 12 is confined within a deforming plane defined by axial directions 52 and 54. In the present embodiment, the deforming plane is substantially perpendicular to the connecting plane.

The relative positioning of adjusting assembly 44 at coupling modules 48 and 50 defines the general direction of deformation within the deforming plane defined by axes 52 and 54. The adjusting assembly 44 may be positioned to apply a restricting force within the deforming plane. In the present invention the restricting force maintains the bending reaction of the flexible portion 14 to 16 such that said bending reaction results in the flexible portion 14 to 16 being preferably deformed away from the adjusting member 46 within the deforming plane.

The perpendicular relation between the connecting plane and the deforming plane permits the adjustment of connectors 34 and 38 such that the relative separation between said connectors is varied while maintaining the required alignment of connectors 34 and 38 with the respective terminals of said connectors.

The allowable deformation within the deformable pipe assembly imposes limitations on the relative separation of the connectors 34 and 38. The relative separation range is defined by any constructional properties of the deformable pipe assembly.

The coupling modules 48 and 50 can be attached to the deformable pipe assembly by a variety of techniques. In some embodiments, the coupling modules 48 and 50 comprise a movable or articulating connection such as rotatable collar or the like to attach the adjusting assembly 44 to the deformable pipe assembly 12. In some embodiments, the coupling modules 48 and 50 are fixed rather than rotatable. In some embodiments, the coupling modules are integrally formed with the deformable pipe assembly 12.

In an embodiment, the coupling modules 48 and 50 comprise coupling components 56 and 58 respectively, which articulate according to the deformable pipe assembly deformation when a restraining force is applied by the adjustment assembly 44, such that undesired stress/strain on the adjusting assembly 44 can be minimised. The coupling component comprises a joint to permit articulation relative to the coupling modules 48 and 50. In the present embodiment, the joint can axially pivot about an axis perpendicular from the deforming plane. In some embodiments, the coupling component comprises a fixed joint to prevent articulation from occurring.

The adjusting assembly 44 comprises a locking module 60 to confine the adjusting member 46 in an adjusted configuration, as required. The locking module comprises any suitable means for locking the deformable pipe assembly 12 into a defined configuration, according to minimum relative separation between the positions defined by coupling modules 48 and 50.

In the present embodiment, the adjusting assembly 44 is used to restrict the deformable pipe assembly in a deformed state according to some external means to passively adjust the adjusting assembly 44. In some embodiments, the adjusting assembly 44 comprises a mechanism to permit the adjustment of the deformable pipe assembly from an initial state to a final state, for example, using an electric motor, pneumatic actuator, hydraulic actuator or the like.

In an embodiment of the present invention, the connection apparatus 10 comprises means to permit installation of the apparatus 10 in situ. In the present embodiment, the deformable pipe assembly 12 comprises a plurality of linking modules 62, 64 and 66 to permit attachment of the apparatus with some installation means, for example, using a lifting rig 68. The linking modules 62, 64 and 66 comprise, for example, a rotatable collar or the like to provide a lifting connection. The linking modules 62, 64 and 66 are positioned at any suitable axial positions within the full length of the deformable pipe assembly 12. Two linking modules 62 and 64 are each positioned at separate equidistant positions within the deformable pipe assembly 12 to permit stable installation of the apparatus 10. Additional linking modules may provide additional stability with which to install the apparatus 10.

The plurality of linking modules is required to ensure stable installation of the apparatus 10. The lifting rig 68 is suitably attached to the linking modules 62, 64 and 66 by some means, for example, using chains, cables or the like, as depicted by numerals 70, 72 and 74. The purpose of the lifting rig 68 is therefore to permit stable operation of the apparatus 10 while the adjusting member 46 and connectors 34 and 38 are adjusted to suitably connect with the terminals 94, 96.

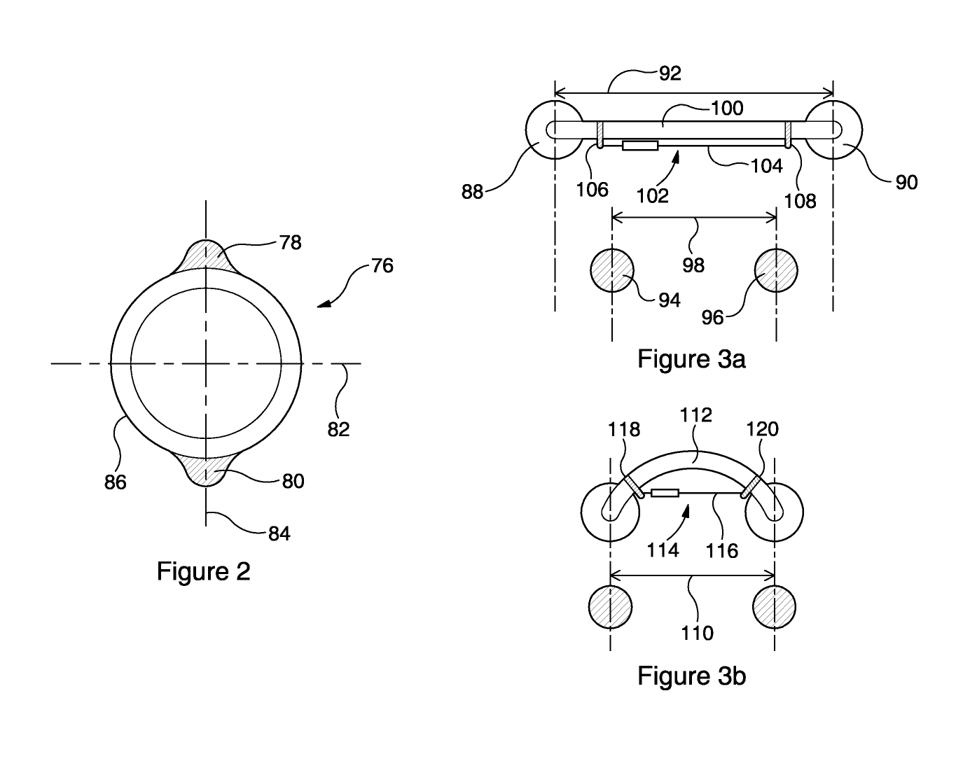

In the embodiment shown in FIG. 2, the deformable pipe assembly 76 (as in 12 of FIG. 1), is seen from an axial cross-section view of said pipe assembly. The deformable pipe assembly 76 is configured to preferentially deform in one direction. In the present embodiment, reinforcing fibres are located in diametrically opposed axial sections 78 and 80 such that the deformable pipe assembly 76 preferentially deforms in a deforming direction 82 and minimises deformation in a stiff direction 84, wherein stiff direction 84 is perpendicular to deforming direction 82. In the present embodiment, the deformable pipe assembly 76 is aligned such that deforming direction 82 is aligned to permit deformation within the deforming plane. However, it will be appreciated that preferential deformation of the pipe may be provided by other techniques, such as varying layups and orientations of reinforcing elements and varying the concentration of reinforcing elements.

The deforming ability of the deformable pipe assembly is provided by a pipe wall 86 comprising a composite material formed of at least a matrix and a plurality of reinforcing elements embedded within the matrix, as depicted by numerals 78 and 80.

FIG. 3a is a view of the apparatus from above with the relative separation between the connectors 88 and 90, as depicted by arrow 92, being different to the separation between a first terminal 94 and a second terminal 96, with the separation depicted by arrow 98. FIG. 3a represents an initial state of the apparatus such that the deformable pipe assembly 100 (12 in FIG. 1) is in a substantially relaxed state. The adjusting assembly 102 (44 in FIG. 1) is adjusted such that the adjusting member 104 (46 in FIG. 1) has a characteristic length according to the relative separation between axially separated coupling modules 106 and 108 (48 and 50, respectively in FIG. 1). In the initial state, the connectors 88 and 90 are too far apart to connect with respective terminals 94 and 96.

FIG. 3b represents a final state of the apparatus, wherein the deformable pipe assembly 112 (100 in FIG. 3a) is deformed to accommodate the required separation between the connectors. Accordingly, the adjusting assembly 114 (102 in FIG. 3a) is adjusted to shorten or retract the adjusting member 116 (relative to the adjusting assembly 104 in FIG. 3a) spanning between axially separated positions depicted by coupling modules 118 and 120 (106 and 108, respectively in FIG. 3a).

FIG. 4a is a side-ways cross-sectional view of the apparatus from the front of the adjusting apparatus 121 with the relative separation between the connectors 122 and 124, as depicted by arrow 126, being different to the separation between the first terminal 128 and the second terminal 130, the terminals 128, 130 having a separation depicted by arrow 132. FIG. 4a is therefore a different representative view of the apparatus in the same initial state as in FIG. 3a. It is clear from this view that the connectors 122 and 124 are too spaced apart compared with terminals 128 and 130, respectively.

FIG. 4b is the same side-ways cross-sectional view of the apparatus as in FIG. 4a with the relative separation 134 between the connectors 136 and 138 being identical to the separation between the terminals 140 and 142. FIG. 4b shows the required final state of the apparatus wherein the deformable pipe assembly 112 (100 in FIG. 3a) is deformed to accommodate the required separation between the connectors. Accordingly, the adjusting assembly 144 is adjusted to permit a relatively shorter adjusting member 146 (than that of the adjusting assembly 104 in FIG. 3a) to span between axially separated positions depicted by coupling modules 148 and 150.

Once the connection apparatus 10 is connected and locked to the terminals 94, 96, 128, 130, 140, 142, the adjusting member can be relaxed, so that the flexible portion 12a is no longer placed under tension. In this way, further movement of the terminals during operation can be accommodated by the inherent compliancy within the structure.

It should be understood that the embodiments described herein are merely exemplary and that various modifications may be made thereto without departing form the scope of the present invention. For example, the perpendicular relation between the connecting and deforming planes may be modified for specific situational instances of terminal locations, as required. Another example could be that the pipe assembly has a unitary construction throughout and a connector between flexible and rigid portions may not be required. A further example could permit a different type of deformation within the flexible portion of the deformable pipe assembly such as coiling, stretching, buckling or the like. A further example could utilise a different adjusting assembly, wherein said adjusting assembly may not directly apply a restricting force between separated regions of the deformable pipe assembly. Instead, a plurality of axially separated communicators may permit adjustment of the deformable pipe assembly through individual force restriction. Furthermore, the apparatus illustrated herein has rigid portions of similar dimensions. However, at least one rigid portion may be of different dimensions to at least one other rigid portion, e.g. the distance from the bend to the connector may differ between rigid portions. In this way, easier connection between the connectors and the terminals may be made in the case where the terminals are at different heights.

In addition, use of different reference numerals in relation to similar features in different drawings is not intended to necessarily imply that those features are different, and instead similar features shown with different reference numerals in different drawings should be considered as including the possibilities that such features could be identical or different.

1-32. (canceled)

33. An apparatus for providing fluid communication between first and second connection points, the apparatus comprising:
a deformable pipe assembly comprising a composite material formed of at least a matrix and a plurality of reinforcing elements embedded within the matrix;
a first connector mounted at one end of the deformable pipe assembly for permitting connection with a first connection point;
a second connector mounted at an opposite end of the deformable pipe assembly for permitting connection with a second connection point; and
an adjusting assembly for applying a force between separated regions of the deformable pipe assembly, such that deformation of the deformable pipeline assembly is responsive to the adjusting assembly to permit a relative separation of the first and second connectors to be adjusted.

34. An apparatus according to claim 33, wherein the apparatus is configured such that the relative orientations of the first and second connectors are unchanged by changes in deformation of the deformable pipe assembly by the adjusting assembly.

35. An apparatus according to claim 33 wherein the adjusting assembly is arranged such that an axis through the separated regions is parallel to an axis defining a separation of the first and second connectors.

36. An apparatus according to claim 36, wherein the deformable pipe assembly comprises a flexible portion.

37. An apparatus according to claim 36, wherein the flexible portion comprises the composite material.

38. An apparatus according to claim 33, comprising one or more sensors for use in determining at least one property of the flexible portion.

39. An apparatus according to claim 33, wherein the deformable pipe assembly is deformable within a deforming plane.

40. An apparatus according to claim 36, wherein the flexible portion is resiliently bendable or flexible.

41. An apparatus according to claim 33, wherein the deformable pipe assembly comprises constructional variations that provide a varying stiffness along the length of the pipe assembly.

42. An apparatus according to claim 36, comprising a rigid pipe portion that has a stiffness greater than the stiffness of at least part of the flexible portion of the deformable pipe assembly.

43. An apparatus according to claim 42, wherein the rigid portion is provided between the deformable pipe assembly and/or the flexible portion thereof and the first and/or second connectors.

44. An apparatus according to claim 42, wherein the rigid portion is comprised in at least one of the deformable pipe assembly, the first connector and the second connector.

45. An apparatus according to claim 42, wherein the rigid portion is comprised in the deformable pipe assembly and the deformable pipe assembly comprises constructional variations that provide a sufficiently high stiffness to provide the rigid portion.

46. An apparatus according to claim 36, wherein the deformable pipe assembly comprises a rigid portion situated at one end of the flexible portion of the pipe assembly.

47. An apparatus according to claim 42, wherein the rigid portion comprises a bend.

48. An apparatus according to claim 36, comprising a first rigid pipe portion at one end of the flexible portion of the deformable pipe assembly, and a second rigid pipe portion at an opposite end of the flexible portion of the deformable pipe assembly.

49. An apparatus according to claim 33, wherein the deformable pipe assembly comprises at least one circumferential constructional variation.

50. An apparatus according to claim 33, wherein the deformable pipe assembly comprises at least one circumferential constructional variation.

51. An apparatus according to claim 49, wherein the at least one circumferential variation comprises diametrically opposed variations in construction.

52. An apparatus according to claim 49, wherein the at least one circumferential constructional variation comprises at least one of variations in thickness, stiffness, strength and provision of a different material to provide different physical characteristics.

53. An apparatus according to claim 33, wherein the deformable pipe assembly comprises at least one longitudinal constructional variation.

54. An apparatus according to claim 33, wherein the adjusting assembly at least one of selectively applies, releases and varies the force between separated regions of the deformable pipe assembly.

55. An apparatus according to claim 33, wherein the deformable pipe assembly is pre-configured by applying a force to obtain a particular relative separation between the connectors ex situ and the action of applying a force to the deformable pipe assembly deforms the deformable pipe assembly from an initially relaxed or less deformed state of the pipe assembly.

56. An apparatus according to claim 33, wherein the adjusting assembly restrains the deformable pipe assembly in a deformed state to maintain the deformation in order to prevent the deformable pipe assembly from self-reconfiguring from the deformed state into the relaxed state of said deformable pipe assembly.

57. An apparatus according to claim 33, wherein the adjusting assembly is coupled to, and/or configured to apply the force to, a part of the pipe assembly that is separated from a longitudinal axis of the pipe assembly.

58. An apparatus according to claim 33, wherein the apparatus comprises a plurality of adjusting assemblies to provide different configurations for adjusting the deformable pipe assembly.

59. An apparatus according to claim 33, wherein the adjusting assembly comprises a coupling at each opposing end of the adjusting assembly, wherein at least one of the couplings comprises a coupling component that can be articulated according to the degree of deformation which occurs when a force is applied using the adjustment assembly.

60. An apparatus according to claim 33, wherein the adjusting assembly comprises one or more force applicators to apply force upon the deformable pipe assembly via the adjusting member in order to adjust the relative separation between the connectors.

61. An apparatus according to claim 33, wherein at least one of the first and second connectors comprise a swivel or other device for allowing reorientation of the first and/or second connectors.

62. A method for installing an apparatus for providing fluid communication between first and second connection points, the apparatus comprising:
a deformable pipe assembly, the deformable pipe assembly comprising at least one flexible portion and at least one rigid portion;
a first connector mounted on the deformable pipe assembly for permitting connection with a first connection point; and
a second connector mounted on the deformable pipe assembly for permitting connection with a second connection point; wherein the method comprises:
utilising an adjusting assembly to apply a force between separated regions of the deformable pipe assembly, such that deformation of the deformable pipe assembly is responsive to the force applied by the adjusting assembly; and
using the adjusting assembly to define a relative separation between the first and second connectors by varying the deformation of the deformable pipeline.

63. The method according to claim 61, comprising adjusting the relative separation between the connectors to permit in situ installation of the apparatus according to the relative separation between the respective first and second connection points.

64. The method according to claim 61, comprising relaxing, loosening or extending the adjusting assembly after the connection apparatus is connected and/or locked to the connection points.
